(19) United States
(12) Patent Application Publication
(10) Pub. No.: US 2008/0134761 A1
(43) Pub. Date: Jun. 12, 2008

(54) Oil Entrapment and Containment Channel for Above Ground Pipelines

(76) Inventor: Peter W. Bryce, Delta (CA)

Correspondence Address: Peter Bryce, 11115 64th Ave, Delta, BC, V4E 1C3, omitted

(21) Appl. No.: 11/567,730

(22) Filed: Dec. 6, 2006

(51) Int. Cl. G01M 3/04

(52) U.S. Cl. 73/40

(57) ABSTRACT

A system is disclosed for the interception, collection, and containment of a leakage of petroleum products from an above ground pipeline or piping. A simply formed grooved channel together with a sorbent material with oleophilic and hydrophobic properties are strapped to the underside of the pipe. A preferred material for the duct is a simple preformed sheet metal or high density polyethylene (HDPE). A second function of the sorbent pad is to prevent the intrusion of wind, dust, water, or snow into the channel.

1. The system comprises a simple preformed metallic channel (4) strapped to the outside of an above ground supported pipeline (12, 14, 15, and 16) or pipe. The pipe may be a bare pipe (1) or and an insulation jacketed pipe (7, 6) as shown in FIGS. 1 & 2.

2. The purpose of the channel is intercept oil that is slowly leaking and freely flowing or oozing from any location around the outside wall of the pipe, leaking as shown by L and following a leak path as indicated by O in FIGS. 1 & 2.

3. The purpose of the channel is to envelop a sorbent material (5) and firmly keep the material pressed up against the underside of the pipe.

4. The channel (5) is strapped (9) to the underside of the pipe with the channel longitudinal axis (10) oriented along the longitudinal axis of the pipe (17).

5. The edges of the channel may be crimped (8) to prevent wildlife from accessing the sorbent material contained in the channel and to catch oil drips.

6. The channel edges contact the pipe at a tangent to the pipe described by the angel theta shown in FIG. 1. The angle theta can be up to 45 degrees.

7. The edges of the channel may be fluted (10) so that oil leaking from a smooth walled pipe will more readily enter the channel.

8. The channel may have small perforations (11) along its bottom edge to allow any rain or snow that may collect in the channel to drain from the bottom when thawed.

9. The channel ends are formed to contain the sorbent material and prevent wildlife from accessing the material.

10. The channel is firmly strapped or banded to the exterior of the pipeline by metallic or plastic straps (9).

11. The sorbent material (5) contained in the channel serves the purpose of absorbing oil and preventing dust, rain, wind or snow from filling the channel.

12. The sorbent material (5) has oleophilic and hydrophobic properties to absorb oil and reject water.

13. The sorbent material (5) will overfill the channel void space so that when it is pressed against the underside of the pipe a relatively wind retardant seal will be formed. The sorbent material may be a folded cloth or stitched to form one or multiple rolls (5).

14. The channel (4) and sorbent material (5) may be produced continuously or in standard lengths depending on the installation requirements.

### DESCRIPTION OF FIGURES

FIG. 1 depicts the cross section of an uninsulated pipeline with two leaks indicated by the letter “L”. The product “O” is flowing towards the bottom of the pipe where it will be intercepted by the V-channel (4). The channel (4) contains a sorbent pad (5).

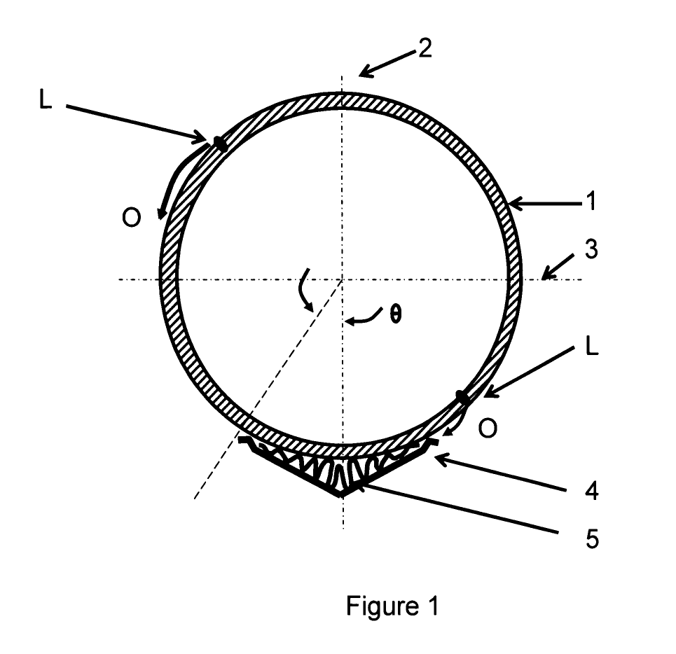

FIG. 2 depicts the cross section of an insulated pipe with a single leak indicated by the letter “L”. The product is flowing downwards to be intercepted by the channel (4) which is strapped to the pipe by straps (9). The channel contains sorbent pad to absorb the hydrocarbon liquid. The V-channel has drainage holes (11) along its length to permit water drainage. The edges of the V-channel may be crimped or fluted to stiffen the channel and enhance fluid recovery.

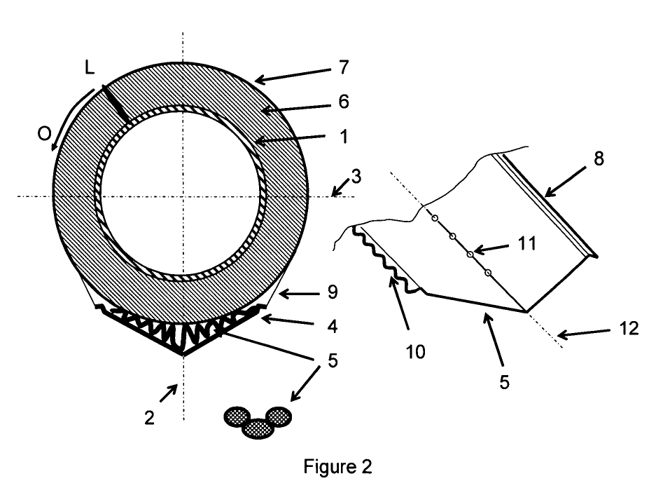

FIG. 3 depicts a side view of an above ground pipeline (1). The pipeline is supported above the ground (16) by vertical support members (15), horizontal support members (14), and a channel supports (13). V-channel (4) is strapped to the pipe by straps (9).

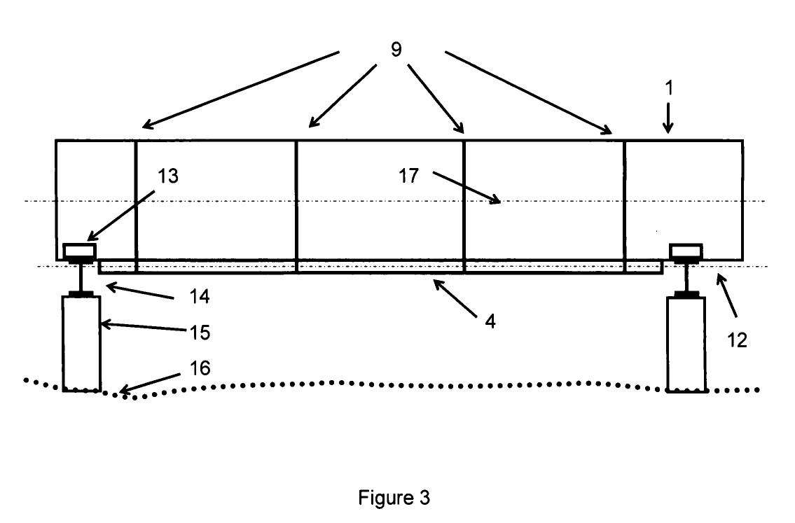

### DRAWING LEGEND

1. Pipeline or pipe outside wall

2. Pipe horizontal axis

3. Pipe vertical axis

4. Channel

5. Sorbent material folded or stitched together

6. Insulation jacket

7. Insulation metallic jacket

8. Channel crimped edge.

9. Holding strap

10. Channel fluted edge

11. Channel drain holes

12. Channel longitudinal axis

13. Pipeline saddle support

14. Horizontal I-beam pipe support

15. Vertical support member

16. Ground or water level

17. Pipe longitudinal axis

1. A leak entrapment and containment system is proposed to intercept, contain and absorb oil products thereby facilitating the detection of a small quantity of oil leaking from an above ground pipeline or piping by other means.

2. The leak interception and containment system is applied to above ground liquid hydrocarbon pipelines with single or multiphase flow conditions.

3. The system collects and absorbs oil products leaking to the outside of the pipe wall or insulation jacketed pipe.

4. The system resists the intrusion of wind, dust, rain, and snow into the channel void space.
